(19) United States
(12) Patent Application Publication
(10) Pub. No.: US 2022/0209811 A1
(43) Pub. Date: Jun. 30, 2022

(54) WIRELESS DEVICE

(71) Applicant: SHARP KABUSHIKI KAISHA, Sakai City, Osaka (JP)

(72) Inventor: MIKIO KURAMOTO, Sakai City, Osaka (JP)

(21) Appl. No.: 17/638,126

(22) PCT Filed: Mar. 11, 2021
(86) PCT No.: PCT/JP2021/009808

§ 371 Date: Feb. 24, 2022

(30) Foreign Application Priority Data
Apr. 6, 2020 (JP) 2020-068315

(51) Int. Cl. H04B 1/44; H04B 1/00

(52) U.S. Cl. CPC H04B 1/44; H04B 1/0064

(57) ABSTRACT

A wireless device includes: a first communicator having a first antenna and a first wireless circuit group including a first wireless circuit connected to the first antenna and communicating using a first band; a first demultiplexer connecting the first antenna and the first wireless circuit; a second communicator having a second antenna and a second wireless circuit group including a second wireless circuit connected to the second antenna and communicating using the first band; a second demultiplexer connecting the second antenna and the second wireless circuit group; a first signal line connecting between the second antenna and the second demultiplexer and between the second demultiplexer and the second wireless circuit; and a first switch switching between a mode of connecting the second antenna and the second wireless circuit through the second demultiplexer and a mode of connecting the second antenna and the second wireless circuit through the first signal line.

### TECHNICAL FIELD

The present invention relates to a wireless device.

This application claims priority based on Japanese Patent Application No. 2020-68315, filed in Japan on Apr. 6, 2020, the contents of which are hereby incorporated herein.

### BACKGROUND ART

A wireless communication terminal device that includes a transceiving antenna and a reception-only antenna and that performs diversity reception is disclosed in PTL 1.

### CITATION LIST

### Patent Literature

### [PTL 1]

Japanese Patent Application Publication No. 2005-151194

### SUMMARY OF THE INVENTION

### Problems to be Solved by the Invention

The following problem possibly occurs to the wireless communication terminal device disclosed in PTL 1. For example, the transceiving antenna and the reception-only antenna interfere with each other, which degrades antenna efficiency.

A primary object of the present disclosure is to provide a wireless device with superior antenna efficiency.

### Solution to Problem

A wireless device according to an aspect of the present invention includes: a first communicator having a first antenna and a first wireless circuit group including plural wireless circuits, the plural wireless circuits including a first wireless circuit that is connected to the first antenna and performs communication by using a first band; a first demultiplexer that connects the first antenna and the first wireless circuit; a second communicator having a second antenna and a second wireless circuit group including plural wireless circuits, the plural wireless circuits including a second wireless circuit that is connected to the second antenna and performs communication by using the first band; a second demultiplexer that connects the second antenna and the second wireless circuit group; a first signal line that connects between the second antenna and the second demultiplexer and between the second demultiplexer and the second wireless circuit; and a first switch that switches between a mode of connecting the second antenna and the second wireless circuit through the second demultiplexer and a mode of connecting the second antenna and the second wireless circuit through the first signal line.

### BRIEF DESCRIPTION OF DRAWINGS

FIG. 1 is a block diagram of a wireless device according to a first embodiment.

FIG. 2 is a schematic view of a part of the wireless device according to the first embodiment.

FIG. 3 is an exemplary graph representing antenna efficiency.

FIG. 4 is an exemplary graph representing antenna return loss.

FIG. 5 is a block diagram of a wireless device according to a second embodiment.

FIG. 6 is a block diagram of a wireless device in a first modified embodiment.

FIG. 7 is a block diagram of a wireless device in a second modified embodiment.

### MODE FOR CARRYING OUT THE INVENTION

A description will hereinafter be made on embodiments of the present invention with reference to the drawings. The same or equivalent elements will be denoted by the same reference sign, and an overlapping description thereon will not be made.

### First Embodiment

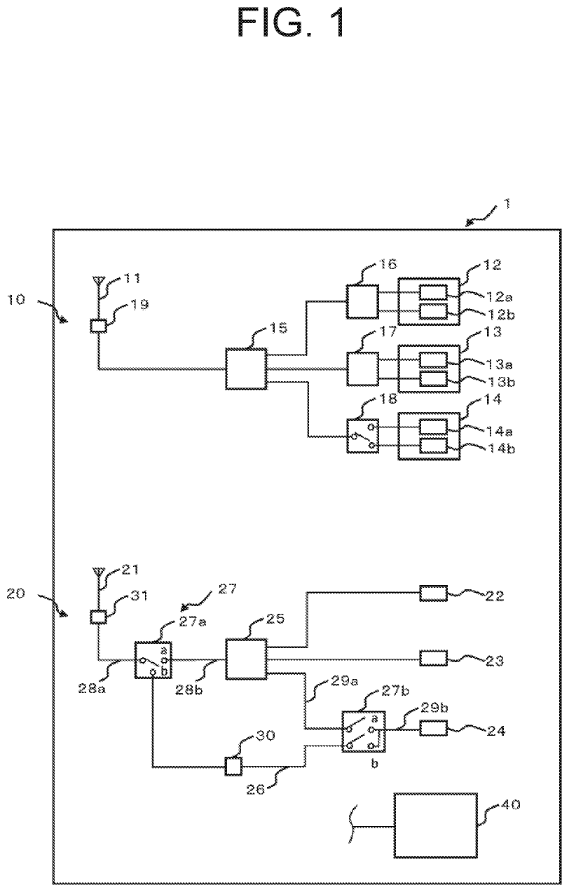

FIG. 1 is a block diagram of a wireless device according to a first embodiment.

A wireless device 1 illustrated in FIG. 1 includes a first communicator 10, a second communicator 20, and a controller 40 that controls both of the communicators.

Each of the first communicator 10 and the second communicator 20 is a component that performs wireless communication. In this embodiment, the first communicator 10 performs transmission and reception. The second communicator 20 performs the reception. The wireless device 1 is a device that can perform diversity communication by using the first communicator 10, which performs the transmission and the reception, and the second communicator 20, which performs the reception.

The first communicator 10 includes a first antenna 11, a first wireless circuit group including plural wireless circuits 12, 13, 14, and a first demultiplexer 15.

Each of the plural wireless circuits 12, 13, 14 in the first wireless circuit group is connected to the first antenna 11. Each of the plural wireless circuits 12, 13, 14 performs the transmission and the reception through the first antenna 11. The plural wireless circuits 12, 13, 14 use mutually-different bands as communication bands.

The plural wireless circuits 12, 13, 14 have transmitters 12a, 13a, 14a and receivers 12b, 13b, 14b, respectively. Each of the transmitters 12a, 13a, 14a performs communication by using a different frequency band from those of the receivers 12b, 13b, 14b.

More specifically, of the plural wireless circuits in the first wireless circuit group, the transmitter 12a included in the third wireless circuit 12 performs the transmission by using a second transmission band. The receiver 12b included in the third wireless circuit 12 performs the reception by using a second reception band.

The transmitter 13a included in the fifth wireless circuit 13 performs the transmission by using a third transmission band. The receiver 13b included in the fifth wireless circuit 13 performs the reception by using a third reception band.

The transmitter 14a included in the first wireless circuit 14 performs the transmission by using a first transmission band. The receiver 14b included in the first wireless circuit 14 performs the reception by using a first reception band.

More specifically, in this embodiment, the first communicator 10 performs the transmission and the reception in bands including a band 1, a band 3, and a band 41. The third wireless circuit 12 performs the transmission and the reception in the band 1. Thus, the second transmission band is a transmission band in the band 1. The second reception band is a reception band in the band 1. The fifth wireless circuit 13 performs the transmission and the reception in the band 3. Thus, the third transmission band is a transmission band in the band 3. The third reception band is a reception band in the band 3. The first wireless circuit 14 performs the transmission and the reception in the band 41. Thus, the first transmission band is a transmission band in the band 41. The first reception band is a reception band in the band 41.

The first demultiplexer 15 is connected between the first antenna 11 and each of the plural wireless circuits 12, 13, 14 in the first wireless circuit group.

The first demultiplexer 15 has: a function of demultiplexing a signal received from the first antenna 11 into the mutually-different frequency bands; and a function of mixing signals received from the plural wireless circuits 12, 13, 14 in the first wireless circuit group.

More specifically, the first antenna 11 receives the signals in frequency bands including the bands (the first reception band, the second reception band, and the third reception band) used by the wireless circuits 12, 13, 14 in the first wireless circuit group for reception. The first demultiplexer 15 distributes, of the signals received by the first antenna 11, the signal in the second reception band to the third wireless circuit 12, the signal in the third reception band to the fifth wireless circuit 13, and the signal in the first reception band to the first wireless circuit 14.

The first demultiplexer 15 receives the signal in the second transmission band from the third wireless circuit 12, the signal in the third transmission band from the fifth wireless circuit 13, and the signal in the first communication band from the first wireless circuit 14. The first demultiplexer 15 mixes those signals and transmits the mixed signal to the first antenna 11.

As it has been described so far, the first demultiplexer 15 demultiplexes the signals into the three mutually-different frequency bands, and mixes the signals in the three mutually-different frequency bands. For this reason, the first demultiplexer 15 can be constructed of a triplexer, for example.

In this embodiment, the plural wireless circuits 12, 13, 14 in the first wireless circuit group respectively have the transmitters 12a, 13a, 14a and the receivers 12b, 13b, 14b, and perform the transmission and the reception. Accordingly, one of demultiplexers 16, 17 and a transceiving switching switch 18 is connected between the first demultiplexer 15 and respective one of the plural wireless circuits 12, 13, 14 in the first wireless circuit group.

The demultiplexer 16 is connected between the first demultiplexer 15 and the third wireless circuit 12. By this demultiplexer 16, of the signals received by the demultiplexer 16, the signal in the second reception band is received by the receiver 12b. The demultiplexer 17 is connected between the first demultiplexer 15 and the fifth wireless circuit 13. By this demultiplexer 17, of the signals received by the demultiplexer 17, the signal in the third reception band is received by the receiver 13b. The transceiving switching switch 18 is connected between the first demultiplexer 15 and the first wireless circuit 14. For example, the communication is performed in a TDD method in the band 41. Thus, by this transceiving switching switch 18, the signal received by the transceiving switching switch 18 is subjected to time-division, and the receiver 14b receives the signal in the first reception band. Each of the demultiplexers 16, 17 can be constructed of a duplexer, for example.

The first communicator 10 further has a matching circuit 19 that is connected between the antenna 11 and the first demultiplexer 15. The matching circuit 19 has a function of matching impedance of the antenna 11 with impedance on a rear side of the matching circuit 19.

The second communicator 20 includes a second antenna 21, a second wireless circuit group including plural wireless circuits 22, 23, 24, a second demultiplexer 25, and a first switch 27.

Each of the plural wireless circuits 22, 23, 24 in the second wireless circuit group is connected to the second antenna 21. Each of the plural wireless circuits 22, 23, 24 performs the reception through the second antenna 21. The plural wireless circuits 22, 23, 24 use mutually-different bands as reception bands. Since the wireless device 1 performs the diversity communication, one of the plural wireless circuits 22, 23, 24 uses the first reception band, another thereof uses the second reception band, and remaining one uses the third reception band. That is, the plural wireless circuits 22, 23, 24 and the receivers 12 b, 13b, 14b use the same three reception bands.

More specifically, in this embodiment, the fourth wireless circuit 22 performs the reception by using the second reception band that belongs to the band 1. The sixth wireless circuit 23 performs the reception by using the third reception band that belongs to the band 3. The second wireless circuit 24 performs the reception by using the first reception band that belongs to the band 41.

The second demultiplexer 25 is connected between the second antenna 21 and each of the plural wireless circuits 22, 23, 24 in the second wireless circuit group. The second demultiplexer 25 has a function of demultiplexing a signal received from the second antenna 21 into the mutually-different frequency bands. More specifically, the second antenna 21 receives the signals in frequency bands including the bands (the first reception band, the second reception band, and the third reception band) used by the wireless circuits 22, 23, 24 in the second wireless circuit group for reception. The second demultiplexer 25 distributes, of the signals received by the second antenna 21, the signal in the second reception band to the fourth wireless circuit 22, the signal in the third reception band to the sixth wireless circuit 23, and the signal in the first reception band to the second wireless circuit 24.

As it has been described so far, the second demultiplexer 25 demultiplexes the signals into the three mutually-different frequency bands. For this reason, the second demultiplexer 25 can be constructed of a triplexer, for example.

The second communicator 20 further has a first signal line 26 and the first switch 27. The first signal line 26 connects between the second antenna 21 and the second demultiplexer 25 and between the second demultiplexer 25 and the second wireless circuit 24.

The first switch 27 switches between the following two modes.

A mode 1 through the second demultiplexer 25: a mode in which the second antenna 21 and the second wireless circuit 24 are connected through the second demultiplexer 25.

A mode 2 without intervening the second demultiplexer 25: a mode in which the second antenna 21 and the second wireless circuit 24 are connected through the first signal line 26.

The first switch 27 is not particularly limited as long as the first switch 27 can switch between the two modes. In this embodiment, the first switch 27 has a switch 27a and a switch 27b.

The switch 27a is connected between the second antenna 21 and each of the second demultiplexer 25 and the first signal line 26. The switch 27a switches between the mode of connecting the second antenna 21 to the second demultiplexer 25 and the mode of connecting the second antenna 21 to the first signal line 26.

The switch 27b is connected between the second wireless circuit 24 and each of the second demultiplexer 25 and the first signal line 26. The switch 27b switches between the mode of connecting the second demultiplexer 25 to the second wireless circuit 24 and the mode of connecting the first signal line 26 to the second wireless circuit 24.

A second signal line that connects the second antenna 21 and the second demultiplexer 25 includes: a second signal line 28a that connects the second antenna 21 and the switch 27a; and a second signal line 28b that connects the switch 27a and the second demultiplexer 25.

A signal line that connects the second demultiplexer 25 and the second wireless circuit 24 has: a signal line 29a that connects the second demultiplexer 25 and the switch 27b; and a signal line 29b that connects the switch 27b and the second wireless circuit 24.

A bandpass filter 30 is provided to the first signal line 26. The bandpass filter 30 is a passband filter (bandpass filter) that allows the signal to pass through the first reception band. Thus, the signal that is input to the second wireless circuit 24 side through the bandpass filter 30 is the signal in the first reception band.

The second communicator 20 further has a second matching circuit 31 between the second antenna 21 and the second demultiplexer 25. The second matching circuit 31 has a function of matching impedance of the second antenna 21 with impedance on a rear side of the second matching circuit 31.

The controller 40 controls each component of the wireless device 1, including the first communicator 10 and the second communicator 20. The controller 40 may include a central processing unit (CPU), a microprocessor unit (MPU), and the like, for example. The controller 40 executes various types of information processing according to a program that is stored in a storage (not illustrated) connected to the controller 40, for example. The storage can be constructed of flash memory, random access memory (RAM), read only memory (ROM), or the like, for example. The storage stores the program executed by the controller 40 and various types of data. The storage also operates as work memory for the controller 40.

When only using the second wireless circuit 24 of the plural wireless circuits 22, 23, 24 in the second wireless circuit group for the communication, the controller 40 controls the first switch 27 such that the second antenna 21 and the second wireless circuit 24 are connected not through the second demultiplexer 25 but through the first signal line 26.

[Operation of Wireless Device]

(Case where at Least Two Wireless Circuits of the Wireless Circuits 22, 23, 24 in the Second Wireless Circuit Group are Used)

In the case where at least two wireless circuits of the wireless circuits 22, 23, 24 in the second wireless circuit group are used, the controller 40 controls the first switch 27 such that the second demultiplexer 25 receives the signal from the second antenna 21. More specifically, the controller 40 uses the switch 27a to connect the signal line 28a and the signal line 28b, and uses the switch 27b to connect the signal line 29a and the signal line 29b. In this way, the plural wireless circuits 22, 23, 24 receive the signal from the second antenna 21.

(Case where Only the Second Wireless Circuit 24 of the Wireless Circuits 22, 23, 24 in the Second Wireless Circuit Group is Used)

In the case where only the second wireless circuit 24 of the wireless circuits 22, 23, 24 in the second wireless circuit group is used, the controller 40 controls the first switch 27 such that the second antenna 21 and the second wireless circuit 24 are connected through the first signal line 26. More specifically, the controller 40 uses the switch 27a to connect the signal line 28a and the first signal line 26, and uses the switch 27b to connect the first signal line 26 and the signal line 29b. In this way, the second wireless circuit 24 receives the signal from the second antenna 21 not through the second demultiplexer 25 but through the first signal line 26. Here, the bandpass filter 30 is provided to the first signal line 26. Accordingly, also when the second wireless circuit 24 receives the reception signal through the first signal line 26, the second wireless circuit 24 receives the reception signal in the first reception band.

By the way, a degree of interference between the first antenna 11 and the second antenna 21 also depends on a termination condition of each of the first antenna 11 and the second antenna 21, that is, impedance of the circuits to which the antennas 11, 21 are connected. For example, the degree of interference between the first antenna 11 and the second antenna 21 varies by which circuit the first antenna 11 is connected, which circuit the second antenna 21 is connected to, and the like. For example, in the case where the first antenna 11 and the second antenna 21 are respectively connected to the demultiplexers 15, 25 that demultiplex the signals in the same frequency band, the interference between the first antenna 11 and the second antenna 21 tends to be complicated and thus is difficult to be handled. In other words, since the demultiplexer only demultiplexes the signal in the particular frequency band, a change in a phase within the frequency band, through which the signal passes, is steep. For example, the band 41 has a bandwidth of 2496 MHz to 2690 MHz. When it is assumed that the phase at 2500 MHz is 0 degree, the phase becomes 180 degrees at 2550 MHz, becomes 0 degree at 2600 MHz, becomes 180 degrees again at 2650 MHz and nearly becomes 0 degree again at 2690 MHz.

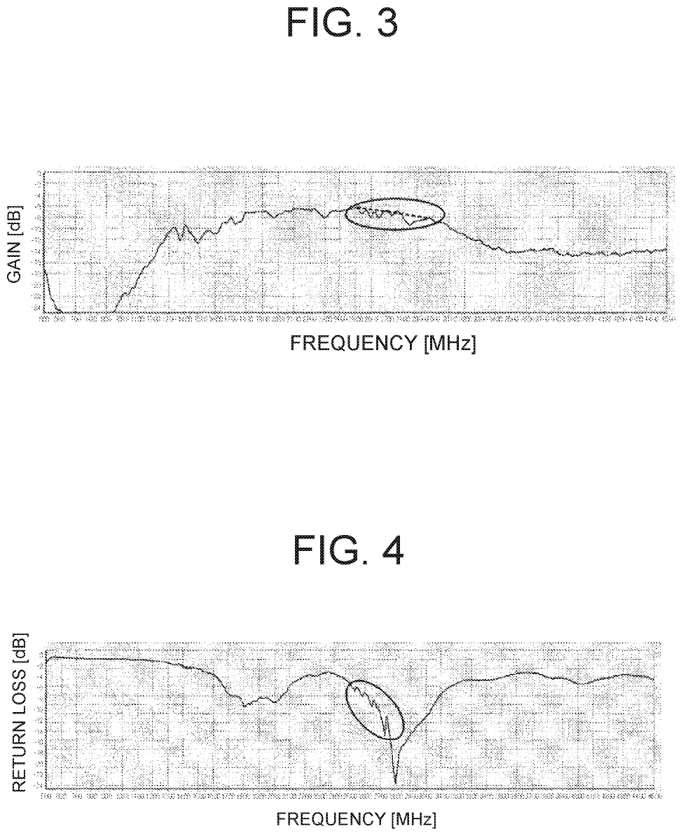

Here, it has been known that, when the antennas are coupled together, performance of each of the antennas may be enhanced or weakened depending on the phase of the other antenna. For example, such a phenomenon occurs that antenna gain of the antenna 11 is increased when the phase of the antenna 21 is 0 degree and the antenna gain of the antenna 11 is reduced when the phase of the antenna 21 is 180 degrees. In this way, ripples as illustrated in FIG. 3 are generated. Parts that strengthen each other are convex, and parts that interfere with each other are concave.

FIG. 3 is a graph representing antenna efficiency of the first antenna 11 at the time when the second antenna 21 and the second wireless circuit 24 are connected through the second demultiplexer 25. FIG. 4 is a graph representing antenna return loss at the time when the second antenna 21 and the second wireless circuit 24 are connected through the second demultiplexer 25. In FIG. 3, a vertical axis represents the gain (dB), and a horizontal axis represents the frequency (MHz). In FIG. 4, a vertical axis represents return loss (dB), and a horizontal axis represents the frequency (MHz).

As illustrated in FIG. 3 and FIG. 4, a large number of the ripples is generated in a circled frequency band of the band 41. It is considered that these ripples are generated due to an influence of the demultiplexer 25.

Accordingly, in this embodiment, in the case where the wireless device performs the communication by using the band 41, the signal from the second antenna 21 is received by the second wireless circuit 24 not through the second demultiplexer 25 but through the first signal line 26. As a result, the second communicator 20 performs the communication without using the second demultiplexer 25, and it is thus possible to suppress the second antenna 21 from interfering with the first antenna 11, which is caused by the second demultiplexer 25. Therefore, the first communicator 10 has the high antenna efficiency. For example, it is possible to obtain the antenna efficiency of the first antenna 11 as a transceiving antenna.

A technique capable of suppressing interference between the plural antennas in this embodiment is further effectively applied when the plural antennas are arranged in close proximity to each other.

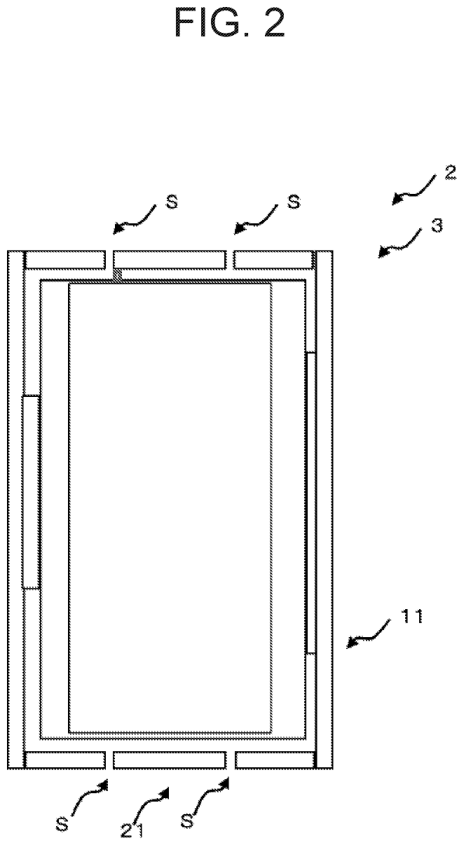

FIG. 2 is a schematic view of a part of the wireless device according to the first embodiment.

In the wireless device 1 illustrated in FIG. 2, a cover that covers outside is removed, and a casing 2 and a metal frame 3 in a rectangular frame shape, which is provided to an edge of the casing 2, are schematically illustrated. The casing 2 accommodates the first communicator 10, the second communicator 20, the controller 40, and the like, which have been described above. The metal frame 3 in the rectangular frame shape is formed with plural slits S. In this way, the first antenna 11 and the second antenna 21 are formed on the metal frame 3. The first antenna 11 and the second antenna 21 are formed in close proximity with the slit S being interposed therebetween. When a width of the slit S is equal to or smaller than ¼ of a center frequency of the first reception frequency band, the first antenna 11 and the second antenna 21 are coupled together, and the mutual interference is often observed in the antenna performance of each other. For this reason, the technique in this embodiment is particularly effective.

A description will hereinafter be made on other examples of the preferred mode for carrying out the present invention. In the following description, members having substantially the same functions as those in the first embodiment will be referred to with the common reference signs, and the description thereon will not be made.

### Second Embodiment

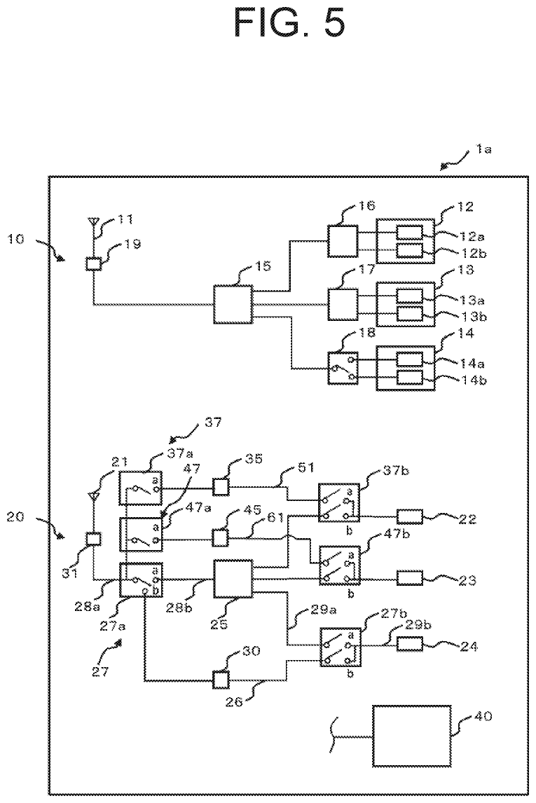

FIG. 5 is a block diagram of a wireless device according to a second embodiment. A wireless device 1a according to the second embodiment differs from the wireless device 1 according to the first embodiment in a point that, in the second communicator 20, second and third signal lines 36, 46 and second and third switches 37, 47 are respectively provided between the second antenna 21 and the other wireless circuits 22, 23.

In the second embodiment, a signal line 51 connects between the second antenna 21 and the second demultiplexer 25 and between the second demultiplexer 25 and the fourth wireless circuit 22. A signal line 61 connects between the second antenna 21 and the second demultiplexer 25 and between the second demultiplexer 25 and the sixth wireless circuit 23.

The wireless device 1a further includes the second switch 37 and the third switch 47.

The second switch 37 switches between the mode of connecting the second antenna 21 and the fourth wireless circuit 22 through the second demultiplexer 25 and the mode of connecting the second antenna 21 and the fourth wireless circuit 22 through the signal line 51. The switch 37 includes a switch 37a and a switch 37b. A bandpass filter 35 that allows the signal to pass through the second reception band is disposed on the signal line 51. Thus, the signal in the second reception band is input to the fourth wireless circuit 22 through the signal line 51.

The third switch 47 switches between the mode of connecting the second antenna 21 and the sixth wireless circuit 23 through the second demultiplexer 25 and the mode of connecting the second antenna 21 and the fourth wireless circuit 22 through the signal line 61. The switch 47 includes a switch 47a and a switch 47b. A bandpass filter 45 that allows the signal to pass through the third reception band is disposed on the signal line 61. Thus, the signal in the third reception band is input to the sixth wireless circuit 23 through the signal line 61.

As it has been described so far, in this embodiment, the signal in the first reception band can be input to the second wireless circuit 24 without interposing the second demultiplexer 25. Not only that, but the signal in the second reception band can be input to the fourth wireless circuit 22 without interposing the second demultiplexer 25. Furthermore, the signal in the third reception band can be input to the sixth wireless circuit 23 without interposing the second demultiplexer 25. Accordingly, in any of the case where only the fourth wireless circuit 22 is used, the case where only the sixth wireless circuit 23 is used, and the case where only the second wireless circuit 24 is used of the wireless circuits 22, 23, 24 in the second wireless circuit group, it is possible to suppress the second antenna 21 from interfering with the first antenna 11, which is caused by the demultiplexer for the second communicator 20. Therefore, the first wireless device 11 has the high antenna efficiency.

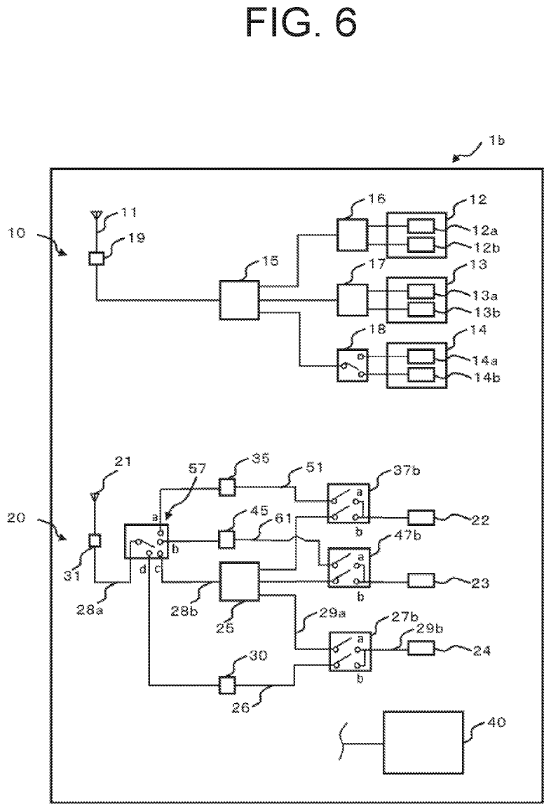

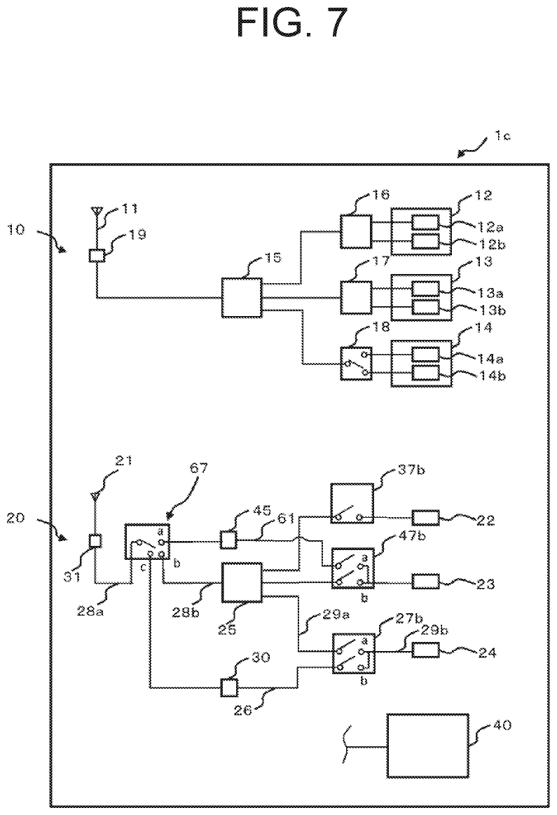

In the wireless device 1a according to the second embodiment, the first switch 27 and the second and third switches 37, 47 are provided in the second communicator 20. Meanwhile, a wireless device 1b in a first modified embodiment, which is illustrated in FIG. 6, may be constructed of a Single Pole Four-way Throw (SP4T) switch 57. Components will be denoted by the same reference signs as those in each of the wireless devices according to the above-described embodiments, and the description thereon will not be made. The wireless device 1b according to this embodiment exerts a similar effect to that in each of the above-described embodiments.

Furthermore, a wireless device 1c in a second modified embodiment, which is illustrated in FIG. 7, may be constructed of a Single Pole Three-way Throw (SP4T) switch 67. More specifically, the first switch includes: a switch 67 that switches among the mode of connecting the second antenna 21 and the second demultiplexer 25, the mode of connecting the second multiplexer 25 and the sixth wireless circuit 23 through the signal line 61, and the mode of connecting the second antenna 21 and the first signal line 26; and the switch 27b that switches between the mode of connecting the second demultiplexer 25 and the second wireless circuit 24 and the mode of connecting the first signal line 26 and the second wireless circuit 24. Components will be denoted by the same reference signs as those in each of the wireless devices according to the above-described embodiments, and the description thereon will not be made. The wireless device 1b according to this embodiment exerts a similar effect to that in each of the above-described embodiments.

The present invention is not limited to the above embodiments and may be replaced with the substantially same configuration as the configuration described in each of the above embodiments, a configuration capable of exerting the same operational effects, or a configuration capable of achieving the same object.

1. A wireless device comprising:
a first communicator having
a first antenna and
a first wireless circuit group including plural wireless circuits, the plural wireless circuits including a first wireless circuit that is connected to the first antenna and performs communication by using a first band;
a first demultiplexer that connects the first antenna and the first wireless circuit group;
a second communicator having
a second antenna and
a second wireless circuit group including plural wireless circuits, the plural wireless circuits including a second wireless circuit that is connected to the second antenna and performs communication by using the first band;
a second demultiplexer that connects the second antenna and the second wireless circuit group;
a first signal line that connects between the second antenna and the second demultiplexer and between the second demultiplexer and the second wireless circuit; and
a first switch that switches between
a mode of connecting the second antenna and the second wireless circuit through the second demultiplexer and
a mode of connecting the second antenna and the second wireless circuit through the first signal line.

2. The wireless device according to claim 1, wherein
the first switch includes:
a switch that switches between a mode of connecting the second antenna and the second demultiplexer and a mode of connecting the second antenna and the first signal line; and
a switch that switches between a mode of connecting the second demultiplexer and the second wireless circuit and a mode of connecting the first signal line and the second wireless circuit.

3. The wireless device according to claim 1, wherein
the first wireless circuit group includes a third wireless circuit that uses a second band differing from the first band,
the second wireless circuit group includes a fourth wireless circuit that uses the second band, the wireless device further comprising:
a second signal line that connects between the second antenna and the second demultiplexer and between the second demultiplexer and the fourth wireless circuit; and
a second switch that switches between a mode of connecting the second antenna and the fourth wireless circuit through the second demultiplexer and a mode of connecting the second antenna and the fourth wireless circuit through the second signal line.

4. The wireless device according to claim 1, wherein
the first wireless circuit group includes a fifth wireless circuit that uses a third band differing from the first band,
the second wireless circuit group includes a sixth wireless circuit that uses the third band,
a third signal line is provided to connect between the second antenna and the second demultiplexer and between the second demultiplexer and the sixth wireless circuit, and
the first switch includes:
a switch that switches among a mode of connecting the second antenna and the second demultiplexer, a mode of connecting the second antenna and the first signal line, and a mode of connecting the second antenna and the third signal line;
a switch that switches between a mode of connecting the second demultiplexer and the second wireless circuit and a mode of connecting the first signal line and the second wireless circuit; and
a switch that switches between a mode of connecting the second demultiplexer and the sixth wireless circuit and a mode of connecting the third signal line and the sixth wireless circuit.

5. The wireless device according to claim 1, wherein
each of the plural wireless circuits in the first wireless circuit group is a transceiver that performs both of transmission and reception, and
each of the plural wireless circuits in the second wireless circuit group is a receiver that performs the reception.

6. The wireless device according to claim 1 further comprising:
a controller that controls the switch such that the second antenna and the second wireless circuit are connected through the first signal line when only the second wireless circuit of the plural wireless circuits in the second wireless circuit group is used for communication.
